(19) United States
(12) Patent Application Publication
(10) Pub. No.: US 2023/0051776 A1
(43) Pub. Date: Feb. 16, 2023

(54) VEHICLE SOFTWARE MANAGEMENT SYSTEM AND METHOD FOR RECOVERING SOFTWARE THEREOF

(71) Applicants: Hyundai Motor Company, Seoul (KR); Kia Corporation, Seoul (KR)

(72) Inventors: Hyeok Sang Jeong, Hwaseong (KR); Myeong Gyu Jeong, Seoul (KR); Jin Ah Kim, Hwaseong (KR); Yoon Sik Jung, Seoul (KR); Hak Jun Kim, Goyang (KR); Dong Youl Lee, Seoul (KR); Young Jee Yang, Seongnam (KR)

(21) Appl. No.: 17/708,812

(22) Filed: Mar. 30, 2022

(30) Foreign Application Priority Data
Aug. 13, 2021 (KR) 10-2021-0107197

(51) Int. Cl. G06F 8/65; G06F 8/71; H04W 4/40

(52) U.S. Cl. CPC G06F 8/65; G06F 8/71; H04W 4/40

(57) ABSTRACT

A vehicle software management system includes a management controller mounted on a vehicle to perform an update of software of a performance controller, and an over-the-air (OTA) server for transmitting a software package for roll back and a software package for the update to the management controller based on whether the management controller has the software package for the roll back, and the management controller performs roll back of the software of the performance controller using the software package for the roll back when the update of the software of the performance controller using the software package for the update fails.

### CROSS-REFERENCE TO RELATED APPLICATION

This application claims under 35 U.S.C. § 119(a) the benefit of Korean Patent Application No. 10-2021-0107197, filed in the Korean Intellectual Property Office on Aug. 13, 2021, the entire contents of which are incorporated herein by reference.

### BACKGROUND

### (a) Technical Field

The present disclosure relates to a vehicle software management system and a method for recovering software thereof.

### (b) Description of the Related Art

An over-the-air (hereinafter, OTA) update technology for a vehicle is a function that supports updating vehicle software by wirelessly downloading update data (e.g., firmware) during travel of the vehicle. An OTA update for the vehicle is executed when an OTA execution condition is satisfied after a download of new software is completed when new software is available (i.e., the latest version of software) by comparing a software version registered in an OTA server with a software version embedded in the vehicle. Such conventional OTA update technology for the vehicle applies a memory dualization scheme for recovery when the update of the new software fails. However, there are many controllers that require software updates in the vehicle, and it is prohibitively expensive to apply the memory dualization scheme to all controllers of the vehicle.

### SUMMARY

An aspect of the present disclosure provides a vehicle software management system and a software method thereof for recovery through roll back when software update for a controller to which a memory dualization scheme is not applied fails.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle software management system includes a management controller mounted on a vehicle to perform an update of software of a performance controller, and an OTA server for transmitting a software package for roll back and a software package for the update to the management controller based on whether the management controller has the software package for the roll back, and the management controller performs roll back of the software of the performance controller using the software package for the roll back when the update of the software of the performance controller using the software package for the update fails.

In one implementation, the OTA server may transmit the software package for the roll back to the management controller.

In one implementation, the OTA server may transmit an update execution command to the management controller along with the software package for the update when the management controller has the software package for the roll back.

In one implementation, the management controller may set the software package for the update as a new software package for the roll back when the update of the software of the performance controller is successful.

In one implementation, the management controller may delete an existing software package for the roll back.

According to another aspect of the present disclosure, a management controller includes a communication device for performing wireless communication with an OTA server, and a processor electrically connected to the communication device, and the processor determines whether the management controller has a software package for roll back when power is supplied to a vehicle, downloads the software package for the roll back from the OTA server when the management controller does not have the software package for the roll back, downloads a software package for update from the OTA server, performs an update of software of a performance controller using the software package for the update, and performs roll back of the software of the performance controller using the software package for the roll back when the update of the software fails.

In one implementation, the processor may determine whether the management controller has the software package for the roll back, and then, transmit vehicle information and version information of the software mounted in the performance controller to the OTA server along with the determination result.

In one implementation, the processor may download the software package for the update from the OTA server when the management controller has the software package for the roll back.

In one implementation, the processor may set the software package for the update as a new software package for the roll back when the update of the software of the performance controller is successful.

In one implementation, the processor may delete an existing software package for the roll back.

In one implementation, the performance controller may be an electric control unit mounted on the vehicle to perform a predetermined function.

According to another aspect of the present disclosure, a method for restoring software of a vehicle software management system includes determining, by a management controller, whether the management controller has a software package for roll back when power is supplied to a vehicle, downloading, by the management controller, the software package for the roll back from an OTA server when the management controller does not have the software package for the roll back, downloading, by the management controller, a software package for update from the OTA server, performing, by the management controller, an update of software of a performance controller using the software package for the update, and performing, by the management controller, roll back of the software of the performance controller using the software package for the roll back when the update of the software fails.

In one implementation, the downloading of the software package for the roll back may include transmitting, by the management controller, vehicle information and version information of the software mounted in the performance controller to the OTA server along with the result of determination on whether the management controller has the software package for the roll back, and transmitting, by the OTA server, the software package for the roll back to the management controller when identifying that the management controller does not have the software package for the roll back based on the result of determination on whether the management controller has the software package for the roll back.

In one implementation, the OTA server may transmit an update execution command to the management controller along with the software package for the update when identifying that the management controller has the software package for the roll back.

In one implementation, the method may further include setting, by the management controller, the software package for the update as a new software package for the roll back when the update of the software of the performance controller is successful.

In one implementation, the method may further include deleting, by the management controller, an existing software package for the roll back.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a software management system for a vehicle according to embodiments of the present disclosure;

FIG. 2 is a flowchart illustrating a software recovery method of a vehicle software management system according to embodiments of the present disclosure; and

FIG. 3 is a block diagram showing a computing system executing a recovery method when vehicle software update fails according to embodiments of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

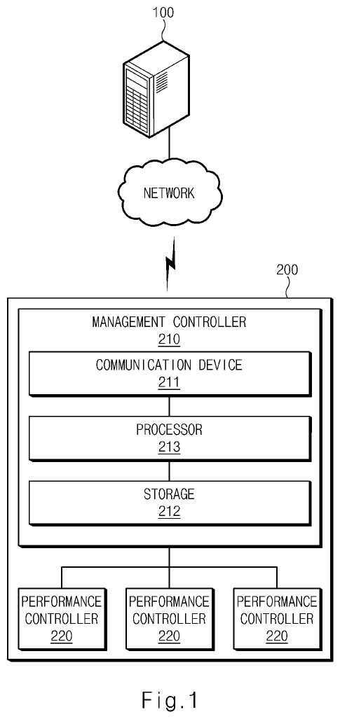

FIG. 1 is a block diagram illustrating a software management system for a vehicle according to embodiments of the present disclosure.

Referring to FIG. 1, a software management system for a vehicle may include an over-the-air (OTA) server 100 and a vehicle 200.

The OTA server 100 may store and manage software (hereinafter, a software) for each vehicle model and each electric control unit (ECU). The OTA server 100 may register a new version software provided by a vehicle manufacturer as a latest version software. The OTA server 100 may transmit version information of the newly registered software to the vehicle 200. In addition, the OTA server 100 may transmit the latest version software in response to a request of the vehicle 200.

The OTA server 100 may receive versions of software of each controller and vehicle information (e.g., the vehicle model, a region, and/or a vehicle identification number (VIN)) transmitted from the vehicle 200. The OTA server 100 may determine a current event version of the vehicle 200 and specify a target event version based on the current event version. The OTA server 100 may command download of a software package for updating to the target event version

In addition, when the vehicle 200 currently does not have a software package for roll back, the OTA server 100 may command download of a software package corresponding to a current event.

The vehicle 200 may include a management controller 210 and at least one performance controller 220 connected to each other through an in-vehicle network (IVN). The in-vehicle network may be implemented as a controller area network (CAN), a media oriented systems transport (MOST) network, a local interconnect network (LIN), an Ethernet, and/or a X-by-Wire (Flexray).

The management controller 210 is a vehicle software management device that manages software version information for each performance controller 220 and hosts OTA updates when update is required. The management controller 210 may download the software package from the OTA server 100 and transmit the software package to the performance controller 220 to execute reprogramming. Such management controller 210 may include a communication device 211, storage 212, and a processor 213. The processor 213 may be electrically connected to the communication device 211 and the storage 212.

The communication device 211 may support wireless communication between the management controller 210 and the OTA server 100. The communication device 211 may include a communication circuit for performing wireless communication such as a vehicle to Infrastructure (V2I) communication, a wireless LAN (WLAN) (Wi-Fi), a wireless broadband (Wibro), a long term evolution (LTE), an international mobile telecommunication (IMT)-2020, a Bluetooth, a near field communication (NFC), and/or the like.

The communication device 211 may download the software package for the update, that is, a latest version software package, from the OTA server 100 in response to an instruction of the processor 213. The communication device 211 may download the software package for the roll back from the OTA server 100. The communication device 211 may transmit version information and/or an update result of the controllers 210 and 220 in the vehicle 200 to the OTA server 100. The communication device 211 may receive an update command transmitted from the OTA server 100.

The storage 212 may store the software package for the update and/or the software package for the roll back received through the communication device 211. The storage 212 may store update management logic and update execution logic executed by the processor 213. The storage 212 may be a non-transitory storage medium that stores instructions executed by the processor 213. The storage 212 may include at least one of storage media such as a flash memory, a hard disk, a solid state disk (SSD), a secure digital card (SD card), a random access memoiy (RAM), a static random access memory (SRAM), a read only memory (ROM), a programmable read only memoiy (PROM), an electrically erasable and programmable ROM (EEPROM), an erasable and programmable ROM (EPROM), a register, an embedded multimedia card (eMMC), and/or a universal flash storage (UFS).

The processor 213 may control an overall operation of the management controller 210. The processor 213 may include at least one of processing devices such as an application specific integrated circuit (ASIC), a digital signal processor (DSP), a programmable logic device (PLD), a field programmable gate array (FPGA), a central processing unit (CPU), a microcontroller, a microprocessor, and/or the like.

The processor 213 may host the update based on the update management logic, and make a request for the communication between the management controller 210 and the OTA server 100 to the communication device 211. In addition, the processor 213 may transmit the software to the performance controller 220 in response to a command transmitted from the update management logic based on the update execution logic, and transmit an update result to the update management logic. When the update of the performance controller 220 fails, the processor 213 may restore the software of the performance controller 220 using the software package for the roll back.

The performance controller 220, which is an OTA update target, may be an electric control unit (ECU) that is mounted on the vehicle and performs a predetermined function (e.g., a driver assistance function and/or an obstacle sensing function). Although not shown in the drawing, the performance controller 220 may include a processor and a memory. The performance controller 220 may receive the software for the update, that is, the latest version software transmitted from the management controller 210, and store the received software for the update in the memory. The performance controller 220 may perform the reprogramming using the software for the update to update control logic stored in the memory in advance. The performance controller 220 may reprogram the software for the update and the software for the rollback in the same scheme.

Hereinafter, a process in which the management controller 210 performs update and recovery of the software of the performance controller 220 will be described in detail.

When the processor 213 of the management controller 210 may determine (check) whether the management controller 210 has the software package for the roll back at a time of ignition (IG) ON or when power is supplied to the vehicle 200. The processor 213 may transmit information of software mounted in each performance controller 220 and the vehicle information to the OTA server 100. The management controller 210 may transmit the result of determination on whether the management controller 210 has the software package for the roll back together when transmitting the software information of each performance controller 220 and the vehicle information. When the management controller 210 notifies that the management controller 210 does not have the software package for the roll back, the OTA server 100 may transmit the software package for the roll back to the management controller 210 first, without determining whether the update is necessary.

The processor 213 of the management controller 210 may download the software package for the roll back, and then, notify that the management controller 210 has the software package for the roll back when transmitting the vehicle information and the software version of each performance controller 220 to the OTA server 100 again. When the management controller 210 has the software package for the roll back, the OTA server 100 may determine whether the update is necessary, and then, instruct to execute the update while transmitting the software package for the update to the management controller 210 when there is new update.

The processor 213 may transmit the software for the update to the performance controller 220 by parsing the software package for the update downloaded from the OTA server 100. The performance controller 220 may update previous version software to the latest version software using the software for the update provided from the management controller 210. The performance controller 220 may transmit an update result including whether the update is successful to the management controller 210 after the update is performed. The performance controller 220 may transmit the update result including an update success or an update failure to the management controller 210.

The processor 213 may determine whether the update of the performance controller 220 is successful based on the update result transmitted from the performance controller 220. When the update of the performance controller 220 is successful, the processor 213 may replace the software package for the update with the software package for the roll back. In other words, the processor 213 may prepare for next update by setting the software package for the update as a new software package for the roll back. The processor 213 may delete the existing software package for the roll back stored in advance.

The processor 213 may transmit the software for the roll back to the performance controller 220 when the update of the performance controller 220 fails. The processor 213 may parse the software package for the roll back stored in advance and transmit the software for the roll back to the performance controller 220. The performance controller 220 may recover from the update failure by performing the roll back using the software for the roll back.

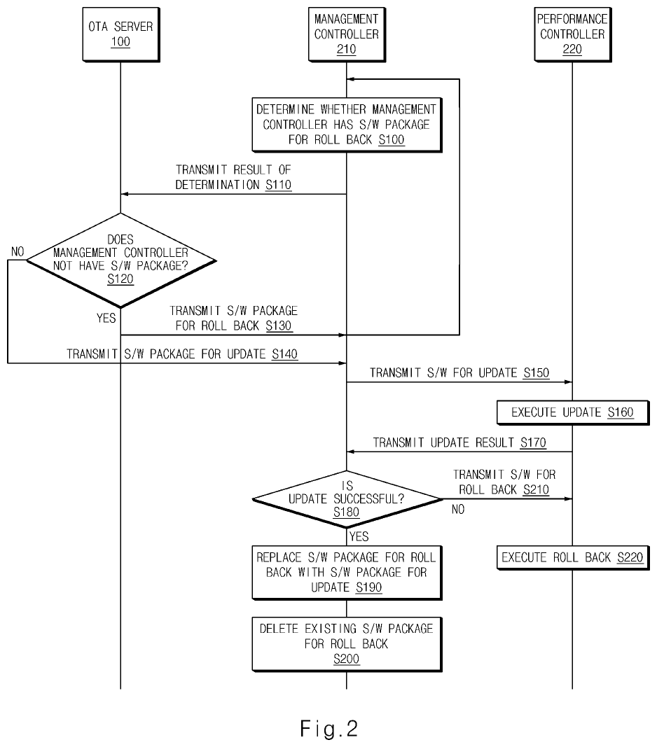

FIG. 2 is a flowchart illustrating a software recovery method of a vehicle software management system according to embodiments of the present disclosure.

The management controller 210 may determine (check) whether the management controller 210 has the software package for the roll back when the power is supplied to the vehicle 200 (S100). The processor 213 of the management controller 210 may determine whether the software package for the roll back is stored in the storage 212.

The management controller 210 may transmit the result of determination on whether the management controller 210 has the software package for the roll back to the OTA server 100 (S110). The management controller 210 may transmit the vehicle information and the version information of the software mounted in each performance controller 220 together to the OTA server 100 when transmitting the result of determination on whether the management controller 210 has the software package for the roll back. The management controller 210 may not have the software package for the roll back immediately after the vehicle 200 is manufactured or when the management controller 210 is replaced with a new one.

The OTA server 100 may determine whether the management controller 210 does not have the software package for the roll back through the result of determination on whether the management controller 210 has the software package for the roll back received from the management controller 210 (S120).

The OTA server 100 may transmit the software package for the roll back to the management controller 210 when the management controller 210 does not have the software package for the roll back (S130).

The OTA server 100 may transmit the software package for the update to the management controller 210 when the management controller 210 has the software package for the roll back (S140). The OTA server 100 may determine whether the software update is necessary based on the vehicle information and the software version information received from management controller 210 when the management controller 210 has the software package for the roll back. The OTA server 100 may compare the version information of the software mounted in the performance controller 220 with version information of the new software registered in the OTA server 100 to determine whether there is the latest version software. When there is the latest version software corresponding to the software mounted in the performance controller 220, the OTA server 100 may transmit the software package for the update including the corresponding latest version software to the management controller 210. In addition, the OTA server 100 may transmit the update execution command to the management controller 210 together with the software package for the update.

The management controller 210 may receive the software package for the update from the OTA server 100 and transmit the software for the update to the performance controller 220 (S150). The management controller 210 may download the software package for the update from the OTA server 100, and then, parse the software package for the update to transmit the software for the update to the performance controller 220.

The performance controller 220 may execute the update of the previous version software to the latest version software using the software for the update provided from the management controller 210 (S160). The performance controller 220 may perform the reprogramming using the software for the update.

The performance controller 220 may transmit the update result including whether the update is successful to the management controller 210 after the update is performed (S170). The performance controller 220 may transmit the update result including the update success or the update failure to the management controller 210.

The management controller 210 may determine whether the update of the performance controller 220 is successful based on the update result transmitted from the performance controller 220 (S180).

The management controller 210 may replace the software package for the roll back with the software package for the update when the update of the performance controller 220 is successful (S190). The management controller 210 may set the software package for the update as the new software package for the roll back.

The management controller 210 may delete the existing software package for the roll back stored in advance (S200). Thereafter, the management controller 210 may use the new software package for the roll back for the roll back at the time of the next update.

When the update failure of the performance controller 220 is identified in S180, the management controller 210 may transmit the software for the roll back to the performance controller 220 (S210). The management controller 210 may parse the software package for the roll back stored in advance and transmit the software for the roll back to the performance controller 220.

The performance controller 220 may perform the roll back using the software for the roll back (S220). Because the performance controller 220 returns the previous software through the roll back, the software may be restored.

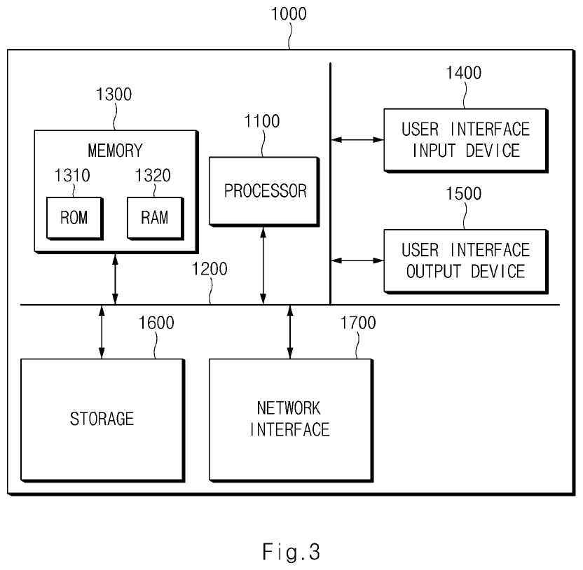

FIG. 3 is a block diagram showing a computing system executing a recovery method when vehicle software update fails according to embodiments of the present disclosure.

Referring to FIG. 3, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor 1100 and the storage medium may reside within an application specific integrated circuit (ASIC). The ASIC may reside within the user terminal. In another method, the processor 1100 and the storage medium may reside as individual components in the user terminal.

The description above is merely illustrative of the technical idea of the present disclosure, and various modifications and changes may be made by those skilled in the art without departing from the essential characteristics of the present disclosure. Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

According to the present disclosure, even when the memory dualization scheme is not applied, when the software update fails, the software may be recovered using the software package for the roll back provided from the server, enabling safer update execution.

In addition, according to the present disclosure, as the software package for the roll back is downloaded from the server before executing the software update, the management controller does not need to have a software package for roll back of another performance controller when assembling the vehicle, so that delivery dependency before the assembly of the vehicle may be deleted.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle software management system comprising:
a management controller mounted on a vehicle to perform an update of software of a performance controller; and
an over-the-air (OTA) server for transmitting a software package for roll back and a software package for the update to the management controller based on whether the management controller has the software package for the roll back,
wherein the management controller is configured to perform roll back of the software of the performance controller using the software package for the roll back when the update of the software of the performance controller using the software package for the update fails.

2. The vehicle software management system of claim 1, wherein the OTA server transmits the software package for the roll back to the management controller.

3. The vehicle software management system of claim 1, wherein the OTA server transmits an update execution command to the management controller along with the software package for the update when the management controller has the software package for the roll back.

4. The vehicle software management system of claim 1, wherein the management controller is configured to set the software package for the update as a new software package for the roll back when the update of the software of the performance controller is successful.

5. The vehicle software management system of claim 1, wherein the management controller is configured to delete an existing software package for the roll back.

6. A management controller comprising:
a communication device for performing wireless communication with an over-the-air (OTA) server; and
a processor electrically connected to the communication device,
wherein the processor is configured to:
determine whether the management controller has a software package for roll back when power is supplied to a vehicle;
download the software package for the roll back from the OTA server when the management controller does not have the software package for the roll back;
download a software package for update from the OTA server;
perform an update of software of a performance controller using the software package for the update; and
perform roll back of the software of the performance controller using the software package for the roll back when the update of the software fails.

7. The management controller of claim 6, wherein the processor is configured to determine whether the management controller has the software package for the roll back, and then, transmit vehicle information and version information of the software mounted in the performance controller to the OTA server along with the determination result.

8. The management controller of claim 6, wherein the processor is configured to download the software package for the update from the OTA server when the management controller has the software package for the roll back.

9. The management controller of claim 6, wherein the processor is configured to set the software package for the update as a new software package for the roll back when the update of the software of the performance controller is successful.

10. The management controller of claim 9, wherein the processor is configured to delete an existing software package for the roll back.

11. The management controller of claim 6, wherein the performance controller is an electric control unit mounted on the vehicle to perform a predetermined function.

12. A method for restoring a software of a vehicle software management system, the method comprising:
determining, by a management controller, whether the management controller has a software package for roll back when power is supplied to a vehicle;
downloading, by the management controller, the software package for the roll back from an over-the-air (OTA) server when the management controller does not have the software package for the roll back;
downloading, by the management controller, a software package for update from the OTA server;
performing, by the management controller, an update of software of a performance controller using the software package for the update; and
performing, by the management controller, roll back of the software of the performance controller using the software package for the roll back when the update of the software fails.

13. The method of claim 12, wherein downloading the software package for the roll back includes:
transmitting, by the management controller, vehicle information and version information of the software mounted in the performance controller to the OTA server along with the result of determination on whether the management controller has the software package for the roll back; and
transmitting, by the OTA server, the software package for the roll back to the management controller when identifying that the management controller does not have the software package for the roll back based on the result of determination on whether the management controller has the software package for the roll back.

14. The method of claim 13, wherein the OTA server transmits an update execution command to the management controller along with the software package for the update when identifying that the management controller has the software package for the roll back.

15. The method of claim 12, further comprising:
setting, by the management controller, the software package for the update as a new software package for the roll back when the update of the software of the performance controller is successful.

16. The method of claim 15, further comprising:
deleting, by the management controller, an existing software package for the roll back.
